(19) United States
(12) Patent Application Publication
(10) Pub. No.: US 2006/0078686 A1
(43) Pub. Date: Apr. 13, 2006

(54) Penetration of copper-ethanolamine complex in wood

(76) Inventors: Robert L. Hodge, Sumter, SC (US); H. Wayne Richardson, Sumter, SC (US)

Correspondence Address: MORGAN LEWIS & BOCKIUS LLP, 1111 PENNSYLVANIA AVENUE NW, WASHINGTON, DC, 20004, US

(21) Appl. No.: 10/960,078

(22) Filed: Oct. 8, 2004

(51) Int. Cl. B05D 3/02; B05D 1/18

(52) U.S. Cl. 427/440; 427/393

(57) ABSTRACT

Addition of base improves the homogeneity of aqueous copper amine complex preservatives injected into wood. The base includes at least a portion of alkali metal hydroxides, alkali metal carbonates, alkali metal phosphates, alkali metal borates, and/or alkali metal pyrophosphates, the corrosivity of the composition to steel and galvanized steel is reduced, and the leach rate of the copper from the wood is also reduced.

### RELATED APPLICATIONS

not applicable

### STATEMENT REGARDING FEDERALLY SPONSORED DEVELOPMENT

not applicable

### INCORPORATION-BY-REFERENCE OF MATERIAL SUBMITTED ON A COMPACT DISC

not applicable

### SEQUENCE LISTING

not applicable

### FIELD OF THE INVENTION

This invention relates to a method of preserving wood with solutions that are injected into wood, comprising adding a basic component to an aqueous copper amine preservative solution in an amount sufficient to prevent copper precipitation during injection, wherein leachability of the copper is reduced and wherein corrosivity of the treated wood is reduced. In particular, the invention relates to adding excess base to the copper amine preservative solution to be injected into wood.

### BACKGROUND OF THE INVENTION

The production of wood which has been treated to inhibit biological decomposition is well known. The primary preserved wood product has historically been southern pine lumber treated with chromated copper arsenate (CCA). In 2003/2004, due in part to regulatory guidelines and to concerns about safety, there has been a substantial cessation of use of CCA-treated products.

A new generation of copper containing wood preservatives use a form of copper that is soluble. Pertinent copper based preservatives include, for example: alkaline (amine or ammonia) copper quats (alkaline copper quaternary, or ACQ); ammoniacal copper zinc arsenate (ACZA); and ammoniacal copper arsenate (ACA).; ammonium/copper complex; copper alkanolamine complexes such as diethanolamine/copper complex, ethanolamine/copper complex, triethanolamine/copper complex, as well as salts thereof, e.g., the copper/ethanolamine/carbonate complex; diethylamine/copper complex; ethylene diamine/copper complex; copper polyaspartic acid complex; bis(N-cyclohexyldiazeniumdioxy)copper; copper azole; copper boron azole; copper bis(dimethyldithiocarbamate); ammoniacal copper citrate, copper ammonium acetate complex, and combinations thereof. Additionally, copper can form a stable aqueous complex with other nitrogen-containing molecules, for example amino acids—e.g., two glycine molecules are required to form a moderately soluble complex with a Cu⁺² atom. Most of the above-listed formulations have not obtained commercial acceptance, generally because of cost.

A related field is post-use preservation. In this case, the wood is preserved, often only in selected spots, with a concentrate or paste that is applied to the wood, is usually protected against drying by a wrap, and is then left to diffuse into the wood. U.S. Pat. No. 6,352,583 describes the use of compositions used as supplemental treatments for subsequent application to wood, which contain a copper compound, an alkanol monoamine and a complexing organic carboxylic acid or its ammonium or alkali salts. WO 96/233635 describes a wood preservative which comprises copper complexes with amino acids, iminodiacetic acid, ethylenediaminotetraacetic acid, dicarboxylic acids and polyphosphates. U.S. Pat. No. 6,110,263 describes the use of copper compound, an inorganic fungicide, and a polyamine or alkanolamine with at least two nitrogen atoms as supplemental treatments, applied for example as wraps. Examples include ethylenediamine, 2-diethylaminoethylamine, diethylenetriamine, triethylenetetramine, tetraethylpentamine, 1,2-diaminopropane, 1,3-diaminopropane, dipropylenetriamine, tripropylenetetramine, 3-(2-aminoethyl)aminopropylamine, N,N′-bis(3-aminopropyl)-1,3-propanediamine, aminoethylethanolamine and mixtures thereof. U.S. Pat. No. 5,242,685 describes an aqueous solution which contains a polycarboxylic acid, ammonia and more than 10% of copper, wherein the composition is made by dissolving copper oxide in an aqueous solution of a polymer acid containing from 60 to 100% of acrylic acid or methacrylic acid and from 0 to 40% of an acrylate or methacrylate monomer with a superpressure of 1.5 to 3 bars ammonia to give a 10% to 100% excess of ammonia based on the carboxylic acid equivalents, wherein the product contains at least 12% weight copper. Such compositions are distinct from initial preservation compositions, in part because there is much less cost pressure on post-use preservatives, and because post-use preservatives cannot get the injection which is a necessary part of this invention.

The principal criteria for commercial acceptance of primary wood preservation treatments, assuming treatment efficacy, is cost. Of the many compositions listed above, only a few soluble copper containing wood preservatives have found wide-spread commercial acceptance: 1) the copper monoethanolamine complex manufactured for example according to the process disclosed in U.S. Pat. No. 6,646,147, and ammoniacal copper complex, optionally with anions such as carbonate, borate, citrate, and the like added to stabilize the copper amine complexes, and typically also including one or more organic biocides. The commercial name of these compositions often does not reflect the presence of the amine complexing agent, e.g., the commercially available copper boron azole.

Modern organic biocides are considered to be relatively environmentally benign and not expected to pose the problems associated with CCA-treated lumber. Biocides such as tebuconazole are quite soluble in common organic solvents while others such as chlorothalonil possess only low solubility. The solubility of organic biocides affects the markets for which the biocide-treated wood products are appropriate. Biocides with good solubility can be dissolved at high concentrations in a small amount of organic solvents, and that solution can be dispersed in water with appropriate emulsifiers to produce an aqueous emulsion. The emulsion can be used in conventional pressure treatments for lumber and wood treated in such a manner that it can be used in products such as decking where the treated wood will come into contact with humans. Biocides which possess low solubility must be incorporated into wood in a solution of a hydrocarbon oil such as AWPA P9 Type A and the resulting organic solution used to treat wood directly. Wood treated in this way can be used only for industrial applications, such as utility poles and railway ties, because the oil is irritating to skin. Some of the more preferred biocides with stability and a broad scope of efficacy but with low solubility even in many solvents, such as chlorothalonil, are underutilized in the wood preservative market because generally incorporating oil into wood products is costly, can adversely affect the paint-ability of the wood, and can impart an odor. Nevertheless, incorporation of one or more organic biocides with an aqueous solution of soluble copper-amine complexes is now the norm in the industry.

There are, however, several problems with these aqueous copper-containing preservatives.

The aqueous soluble-copper-containing wood preservatives are very leachable compared to CCA. One study has shown that as much as 80 percent of the copper from a copper amine carbonate complex is removed in about 10 years under a given set of field conditions. Under severe conditions such as the those used for the American Wood Preserving Association's standard leaching test, these products are quickly leached from the wood. For example, we found that 77% by weight of a Cu-monoethanolamine preservative was leached from the preserved wood in 14 days. This leaching is of concern for at least two reasons: 1) removal of the copper portion of the pesticide from the wood by leaching will compromise the long term efficacy of the formulation, and 2) the leached copper causes concern that the environment will be contaminated. While most animals tolerate copper, copper is extremely toxic to certain fish at sub-part per million levels. Common ranges for EC₅₀ for copper are between 2 and 12 micrograms per liter. Another study reported following the Synthetic Precipitation Leaching Procedure, the leachate from CCA-treated wood contained about 4 mg copper per liter; leachate from copper boron azole-treated wood contained about 28 mg copper per liter; leachate from copper bis(dimethyldithiocarbamate) treated wood had 7 to 8 mg copper per liter; leachate from alkaline copper quaternary treated wood had 29 mg copper per liter; and leachate from copper citrate treated wood had 62 mg copper per liter. However, copper concentrations depend in part on copper concentration, and CCA had about 7% of total copper leach, the alkaline copper quaternary preservative had about 12% of the total copper leach, while the copper boron azole had about 22% of the total copper leach during the Synthetic Precipitation Leaching Procedure. Copper leaching is such a problem that some states do not allow use of wood treated with the soluble copper containing wood preservatives near waterways, and problems of shortened life-span of the products due to leaching are impending.

The leaching of copper preservatives can be controlled by using for example an oil barrier. But these oils can unfavorably change the color, appearance, and burning properties of the wood, and can be strong irritants. Japanese Patent Application 08-183,010 JP, published in 1996, describes a modified wood claimed to have mildew-proofing and antiseptic properties and ant-proofing properties, made by treating wood with a processing liquid containing a copper salt and linseed oil or another liquid hardening composition. U.S. Pat. No. 3,837,875 describes as a composition for cleaning, sealing, preserving, protecting and beautifying host materials such as wood a mixture of boiled linseed oil, turpentine, pine oil, a dryer and 28 parts per million of metallic copper. Feist and Mraz, Forest Products Lab Madison Wis., Wood Finishing: Water Repellents and Water-Repellent Preservatives. Revision, Report Number-FSRN-FPL-0124-Rev (NTIS 1978) discloses preservatives containing a substance that repels water (usually paraffin wax or related material), a resin or drying oil, and a solvent such as turpentine or mineral spirits. Addition of a preservative such as copper naphthenate to the water repellent is asserted to protect wood surfaces against decay and mildew organisms. Soviet Union Patent No. SU 642166 describes a wood surface staining and preservation treatment, carried out by impregnating wood with an aqueous copper salt solution, followed by thermal treatment in boiling drying oil containing 8-hydroxyquinoline dye. U.S. published application 20030108759 describes injecting a copper ammonium acetate complex and a drying oil as a wood preservative. U.S. Pat. No. 6,340,384 describes treating wood with a composition comprising: amine oxides, and a biocidally effective amount of one or more aqueous copper amine complexes. U.S. Pat. No. 6,521,288 describes adding certain organic biocides to polymeric nanoparticles (particles), and claim benefits including: 1) protecting the biocides during processing, 2) having an ability to incorporate water-insoluble biocides, 3) that since the polymer component acts as a diluent a more even distribution of the biocide is achieved than the prior art method of incorporating small particles of the biocide into the wood, and finally that leaching is reduced with nanoparticles, and the biocide will be protected within the polymer from environmental degradation. The application states that the method is useful for biocides including chlorinated hydrocarbons, organometallics, halogen-releasing compounds, metallic salts, organic sulfur compounds, compounds and phenolics, and preferred embodiments include copper naphthenate, zinc naphthenate, quaternary ammonium salts, pentachlorophenol, tebuconazole, chlorothalonil, chlorpyrifos, isothiazolones, propiconazole, other triazoles, pyrethroids, and other insecticides, imidichloprid, oxine copper and the like, and also nanoparticles with variable release rates that incorporate inorganic preservatives as boric acid, sodium borate salts, zinc borate, copper salts and zinc salts. The only examples used the organic biocides tebuconazole and chlorothalonil incorporated in polymeric nanoparticles. There is no enabling disclosure relating to any metal salts. While data was presented showing efficacy of tebuconazole/polymeric nanoparticle formulations and chlorothalonil/polymeric nanoparticle formulations in wood, the efficacy of these treatments was not compared to those found when using other methods of injecting the same biocide loading into wood. Efficacy/leach resistance data was presented on wood product material, where it was found that the nanoparticle/biocide treated wood had the same properties as the wood product treated with a solution of the biocide, i.e., the polymeric nanoparticles had no effect. This treatment has not had commercial success. Again, polymers and oil are not favored as they are costly, they can alter characteristics of wood, they can be staining and/or discoloring, they can be cost-prohibitive, and they can be an irritant. It is also difficult to work with and to inject polymers and oil into wood. None of the methods of preserving wood described in this paragraph have met commercial acceptance.

A second problem with soluble copper solutions is that the use thereof is associated with significantly increased metal corrosion, for example of nails within the treated wood. The mechanism for the increased corrosion has not been conclusively identified. Preserved wood products are often used in load-bearing out-door structures such as decks. The increased and unexpected corrosion of metallic fasteners can result in un-safe structures. Traditional fastening material, including aluminum and standard galvanized fittings, are not suitable for use with wood treated with these new preservatives. Many regions are now specifying that hardware, e.g., fittings, nails, screws, and fasteners, be either galvanized with 1.85 ounces zinc per square foot (a G-185 coating) or require Type 304 stainless steel. This increases the costs of using the treated lumber.

A third problem is a difficulty in obtaining homogenous injection and composition distributions in thicker wood, e.g., often in wood having a thickness of one inch, and usually in wood having a thickness of two inches or greater. It is known generally in the industry that soluble alkaline wood preservatives do not penetrate as well as acidic materials (such as CCA). Rather, what is observed is splotchy, heterogeneous accumulations of what appear to be copper-containing precipitates at the inner portions of the wood.

What is needed is an improved composition and treatment to improve injected copper homogeneity in wood. What is also needed are treatments to reduce corrosion rates of metals contacting the treated wood. What is also needed are treatments to reduce copper leach rates. The present invention solves each of the above problems.

### SUMMARY OF THE INVENTION

In a first aspect of the invention, wood is preserved by: 1) providing an aqueous solution comprising at least one soluble copper amine complex and at least one base in an amount sufficient to provide at least about 0.8, preferably 1 or greater, and more preferably 1.5 or greater, for example between about 2 and about 4, mole-equivalents of base for each mole of soluble copper amine complex; and 2) injecting the solution comprising copper amine complex and the base into wood.

In a second aspect of the invention, wood is preserved by: 1) contacting the wood with a composition comprising a base, such that an amount of the base remains on or in the wood; and 2) injecting into the wood comprising the base with an aqueous solution comprising at least one copper amine complex, wherein the amount of base on and/or in the wood is sufficient to reduce premature precipitation of copper from the subsequently injected aqueous solution containing the copper amine complex. In one embodiment the composition comprising a base is a gas which on contact with water forms a base, for example ammonia gas. In the preferred embodiments, the composition comprising the base is an aqueous composition comprising at least one base in an amount sufficient to provide at least about 0.02, preferably 0.03 or greater, and more preferably 0.05 or greater, for example between about 0.05 and about 0.3, mole-equivalents of base per liter of aqueous solution. Preferably at least a portion of the base is not an amine. A preferred amount of base is between about 0.05 and about 0.2 mole-equivalents of base per liter of aqueous solution.

In a third aspect of the invention, wood is preserved by: 1) providing an aqueous solution comprising at least one copper amine complex and at least one base in an amount sufficient to provide at least about 0.2, preferably 0.4 or greater, and more preferably 1 or greater, for example between about 1.2 and about 4, mole-equivalents of base for each mole of copper; wherein the base is not an amine; and 2) injecting the solution comprising the copper amine complex and the base into wood.

In a fourth aspect of the invention, wood is preserved by: 1) providing an aqueous solution comprising at least one soluble copper amine complex and at least one base in an amount sufficient to provide at least about 0.01, preferably 0.02 or greater, and more preferably 0.03 or greater, for example between about 0.04 and about 0.4, mole-equivalents of base per liter of aqueous solution, wherein the base is not an amine; and 2) injecting the solution comprising copper amine complex and the base into wood. A preferred amount of base is between about 0.05 and about 0.2 mole-equivalents of base per liter of aqueous solution.

In a fifth aspect of the invention, wood is preserved by: 1) providing an aqueous solution comprising at least one soluble copper amine complex and at least one base in an amount sufficient to provide at least about 0.02, preferably 0.03 or greater, and more preferably 0.05 or greater, for example between about 0.1 and about 0.4, mole-equivalents of base per liter of aqueous solution, wherein at least a portion of the base is not an amine; and 2) injecting the solution comprising copper amine complex and the base into wood. In an alternate fifth embodiment, the base is not the amine forming part of the copper amine complex. A preferred amount of base is between about 0.05 and about 0.3 mole-equivalents of base per liter of aqueous solution.

In a sixth aspect of the invention, wood is preserved by: 1) providing an aqueous solution comprising at least one soluble copper amine complex and at least one base in an amount sufficient to provide at least about 0.03, preferably 0.05 or greater, and more preferably 0.07 or greater, for example between about 0.1 and about 0.4, mole-equivalents of base per liter of aqueous solution; and injecting the solution comprising copper amine complex and the base into wood. A preferred amount of base is between about 0.05 and about 0.2 mole-equivalents of base per liter of aqueous solution.

In each of the six aspects of the invention described above, the amine in the copper amine complex can advantageously comprise ammonia, an alkanolamine; for example an ethanolamine, preferably monoethanolamine; a diamine, for example ethylene diamine or derivative thereof, more preferably ethylenediamine; a polyamine; an amino compound including amino acids; a water-miscible nitrile; a carbamate or thiocarbamate; or mixtures or combinations thereof, so long as the amine(s) combine with copper to form soluble copper amine complexes. The preferred amine in the copper amine complex is ammonia, an alkanolamine; for example an ethanolamine, preferably monoethanolamine; a diamine, for example ethylene diamine or derivative thereof, more preferably ethylenediamine; or mixtures or combinations thereof. The more preferred amine forming the copper amine complex is ammonia, an ethanolamine, preferably monoethanolamine; or mixtures or combinations thereof.

In each of the six aspects of the invention described above, the base advantageously comprises alkali metal carbonates, alkali metal hydroxides, alkali metal oxides, alkali metal methoxides, alkaline earth metal hydroxides, alkaline earth metal oxides, basic phosphate, wherein the term “basic” means the compound contains only alkali metal ions and no H⁺, e.g., tri-sodium phosphate, basic pyrophosphate, basic borate, or mixtures thereof. In each of the six aspects of the invention described above, the base can comprise any of the bases listed above, and at least a portion of the base can alternately comprise an basic salt of a C1 to C6 mono- or poly-carboxylic acid, a basic salt of a C1 to C6 mono- or poly-sulfonic acid, or combination thereof. In selected aspects of the invention, the exemplary base can comprise any of the bases listed above, and at least a portion of the base can alternately comprise an amine, ammonia, an alkanolamine; for example an ethanolamine, preferably monoethanolamine; a diamine, for example ethylene diamine or derivative thereof, more preferably ethylenediamine; a polyamine; or mixtures or combinations thereof. The preferred bases include alkali metal carbonates, alkali metal hydroxides, basic phosphate, basic pyrophosphate, or mixtures thereof, and in the first, second, fifth and sixth aspects of the invention also include ammonia, an alkanolamine; for example MEA; a diamine, for example ethylenediamine; or mixtures or combinations thereof. The most preferred bases comprise alkali metal carbonates, alkali metal hydroxides, or mixture thereof. The preferred alkalis are sodium and/or potassium. The most preferred base is sodium carbonate.

In each of the six aspects of the invention described above, the aqueous solution comprising at least one soluble copper amine complex advantageously has soluble copper in an amount between about 0.03% to about 1.5% soluble copper, typically between about 0.08% soluble copper and about 0.4% soluble copper.

In each of the above six embodiments, the act of injecting advantageously comprises application of vacuum, pressure, or both, to facilitate deeper injection of the aqueous solution into the wood.

In each of the above embodiments, advantageously the wood is at least partially dried after being injected with the aqueous solution and base.

### BRIEF DESCRIPTION OF DRAWINGS

FIG. 1 shows photographs of dipped galvanized and electrogalvanized nails used in corrosion tests described in the Examples.

FIG. 2 shows photographs of Southern Pine wood dipped in a typical aqueous copper-MEA-carbonate solution, and another dipped in the aqueous copper-MEA-carbonate solution plus soda ash.

FIG. 3 shows photographs of Southern Pine wood dipped in a typical aqueous copper-MEA-carbonate solution, another dipped in the aqueous copper-MEA-carbonate solution plus added MEA, and two samples dipped in a standard wood preservative solution containing different quantities of soda ash.

FIG. 4 shows results of leach test on wood treated with the standard wood preservative solution (CA), the results of leach tests on wood treated with the standard wood preservative solution plus different quantities of excess MEA (CA+a), (CA+b), and (CA+d), and the results of leach tests on wood treated with the standard wood preservative solution plus soda ash (CA+d).

### DETAILED DESCRIPTION OF PREFERRED EMBODIMENTS

In a first aspect of the invention, wood is preserved by: 1) providing an aqueous solution comprising at least one soluble copper amine complex and at least one base in an amount sufficient to provide at least about 0.8, preferably 1 or greater, and more preferably at least 1.5 or greater, for example between about 2 and about 4 mole-equivalents of base for each mole of soluble copper amine complex; and 2) injecting the solution comprising copper amine complex and the base into wood. This aspect of the invention, relating excess base to the concentration of soluble copper, is an imperfect reflection that higher concentrations of copper amine will be prone to greater problems if precipitation of gelatinous copper products begins, and therefore higher concentrations of copper amine should for the sake of caution have higher concentrations of base.

The amine(s) that are in copper amine complexes are not considered to be “base” as the word is used herein. It is possible to have a variety of amines that complex in various combinations with copper. While various amines have certain ratios where copper forms a stable complex in an aqueous solution, the ratios may change somewhat with changes in the amine concentration and other parameters. Therefore, it is important for some claims to know how much of an amine is a base and how much of an amine is part of a copper amine complex. As used herein, except for the explicitly defined ratios for the copper-MEA complex and for copper-ammonia complex, the ratio of amines to copper that reside in various complexes is defined by determining how much soluble copper(II) is in equilibrium in a solution consisting essentially of water, 3 moles of the amine(s), a divalent anion such as carbonate, and optionally about 1% carbon dioxide (as carbonate), where the solution is in equilibrium with basic copper carbonate. If a mixture of copper(I) and copper(II) are present, the test is done with the proportion of copper(I) to copper(II) found in the process.

Copper complexed with monoethanolamine (“MEA”) requires between about 3.2 and about 3.3 moles of MEA to complex one mole of Cu⁺². For use in evaluating the invention, in an aqueous composition consisting essentially of copper, MEA, and an ion such as carbonate, borate, or sulfate, we use a ratio of 3.25 moles MEA to 1 mole Cu⁺², or 3.17 parts by weight MEA per part copper, as the amount of MEA in the copper amine complex.

In each of the various aspects of the invention, the base can comprise alkali metal carbonates, alkali metal hydroxides, alkali metal oxides, alkali metal methoxides, alkaline earth metal hydroxides, alkaline earth metal oxides, basic (tri-alkali metal) phosphate, basic pyrophosphate, basic borate, or mixtures thereof. In each of the six aspects of the invention described above, the base can comprise any of the bases listed above, and at least a portion of the base can alternately comprise a basic salt of a C1 to C6 mono or poly-carboxylic acid, a basic salt of a C1 to C6 mono- or poly-sulfonic acid, or mixtures of or combination thereof. In selected aspects of the invention, the exemplary base can comprise any of the bases listed above, and at least a portion of the base can alternately comprise an amine, for example ammonia, an alkanolamine; for example an ethanolamine, preferably monoethanolamine; a diamine, for example ethylene diamine or derivative thereof, more preferably ethylenediamine; a polyamine; or mixtures or combinations thereof. The preferred bases include alkali metal carbonates, alkali metal hydroxides, basic phosphate, basic pyrophosphate, and in selected aspects of the invention also include ammonia, an alkanolamine; for example MEA; a diamine, for example ethylenediamine; or mixtures or combinations thereof. The most preferred bases comprise alkali metal carbonates, alkali metal hydroxides, or mixture thereof. The preferred alkali metals are sodium and/or potassium. The most preferred base is sodium carbonate.

In each of the above embodiments, exemplary preferred bases are strong bases, i.e., sodium hydroxide, potassium hydroxide, soda ash or sodium carbonate, potassium carbonate, lithium carbonate, lithium hydroxide, or mixture thereof. If alkali metal hydroxides are present in amounts greater than about 2 moles per mole of copper, the alkali metal hydroxides and oxides will destabilize the copper amine and cause undesired precipitation of copper hydroxide. While alkali metal hydroxides are a preferred base, care should be taken to avoid conditions where the alkali metal hydroxide is present in sufficient quantities to destabilize the copper amine complex. Generally, the molar ratio of alkali metal hydroxides to copper should be below about 3, preferably below about 2.4, more preferably below about 2, for example below about 1.5. Under some conditions, hydroxide will destabilize the copper amine complex and strip copper away. The stripped copper then immediately precipitates as the hydroxide. Its preferred, if the mole equivalents of base per mole of copper exceed 1.5, that at least a portion of the base comprise a buffering base, for example a alkali metal carbonate, a basic alkali metal phosphate, a basic pyrophosphate, a basic borate, or one or more weaker bases such as amines, basic organic acid salts and the like.

Alkali metal oxides and alkali methoxides are usable, but tend to be more expensive or difficult to handle than the counterpart hydroxides or carbonates. Alkali metal oxides and alkali metal methoxides act in a manner similar to alkali metal hydroxides, and the absolute amount of these compounds is beneficially less than 1.5 mole-equivalents per mole of copper.

Alkaline earth hydroxides and oxides are useful but less preferred, because there is often carbonates in the aqueous copper amine solutions. Indeed, the most preferred bases are alkali metal carbonates. Conditions where calcium, magnesium, and/or strontium carbonate may precipitate are to be avoided. Also, these bases are fairly weak, and are therefore not efficient at neutralizing acids in wood.

Certain basic organic carboxylates, such as an alkali acetate, can be useful as bases. However, they are weaker bases, and will be less effective than the stronger bases at neutralizing acids in wood. and at protecting the aqueous composition.

Basic phosphates, basic borates, and basic pyrophosphates are useful as bases. Phosphates will reduce corrosion in certain circumstances, and will also tend to reduce copper leaching. It should be noted that a mole of tri-basic sodium phosphate will, however, provide only about one and a half mole equivalents of base. Borates have biocidal benefits, but act as poor bases, and a mole of basic borate provides about 1 mole equivalent of base. Basic pyrophosphates are good bases, and while a mole of basic alkali pyrophosphate will provide only between about 1 and about 2 moles equivalent of base, the compound also acts as a sequestering agent, which is useful if there is appreciable alkaline earth metal concentrations.

Historically, there has often been a misconception that 4 moles MEA are required to complex a mole of copper. Since the copper-MEA complex used only 3.27 moles MEA per mole of copper, a composition made with 4 moles MEA per mole of copper will have about 0.75 moles of MEA that is not contained in copper MEA complexes. This MEA will act as a base. We expect that the prior art therefore contains examples where excess base, in the form of excess MEA, was used. Copper MEA solutions containing 4 moles MEA per mole of copper would have about 0.75 mole equivalents of MEA as base per mole of copper. The current inventors use a ratio of 3.5 moles MEA per mole of copper to maintain a fast production rate of copper-MEA-carbonate. See, for example, U.S. Pat. No. 6,646,147, the disclosure of which is incorporated by reference. A copper MEA solution with 3.5 moles MEA per mole of copper total will have 3.25 moles MEA per mole of copper in the form of the copper-MEA complex and would have about 0.25 mole equivalents of MEA as base per mole of copper. Comparative sample 1 in Example 1 in fact had about 0.4 mole equivalents of MEA as a base per mole of copper.

In most embodiments of the invention, MEA, ammonia, and other amines, are not preferred bases, especially if they comprise essentially all the free base. One reason is cost—amines are expensive relative to alkali metal carbonates—and the other reason is that the amines increase the leaching rate of copper from wood.

Ammonium hydroxide, monoethanolamine, and ethylene diamine are all fairly strong bases. These compounds typically form the copper amine complexes. Therefore, there is typically a slight excess of one or more of ammonium hydroxide, monoethanolamine, and/or ethylene diamine, relative to the amount needed to complex the copper. The literature contains many statements that copper leaching from wood is reduced by the addition of ethanolamine. See, for example, Miha Humar et al., Performance of Waterborne Cu(II)Octanoate/Ethanolamine Wood Preservatives, Cu(II) Wood Preservatives, Holzforschung, Vol 57, pg 127-134 (2003). Surprisingly, however, we found that having certain amounts of excess MEA, above the amount needed to form the copper-MEA complexes to keep the copper in solution, increased leaching of copper. In some embodiments of this invention, the amount of excess amine in the aqueous solution of copper-amine complexes, for example excess ammonium hydroxide, monoethanolamine, and/or ethylene diamine, is less than 0.25 times, preferably less than 0.15 times, more preferably less than 0.1 times, the amount of these components present in the copper amine complexes. In some alternate embodiments of this invention, the amount of excess amine in the aqueous solution of copper-amine complexes is less than 1 mole equivalent per mole of copper, preferably less than 0.5 mole equivalents per mole of copper. The use of amine compounds as bases, particularly the ethylene diamines and the alkanolamines, is very expensive compared to the alkali hydroxides.

Excess MEA added as a base encourages the leaching of copper from wood, while certain other bases discourage copper leaching from wood. Excess MEA added as a base is not as effective as other bases at mitigating corrosion. Finally, a substantial fraction of the MEA eventually migrates from the wood, leaving no residual effect which would tend to reduce copper solubility and therefore reduce copper leaching from wood. For these reasons, in preferred embodiments of the invention, the quantity of excess MEA (or any other amine) is preferably less than 1 mole equivalent per mole of copper, and the preferred compositions advantageously further comprise at least 0.1 mole equivalents of non-amine base per mole of copper.

For similar reasons, ammonia and other amines incorporated in the copper amine complexes are not a preferred base. However, we recognize that, like the copper MEA compositions discussed above, excess ammonia will usually be present in any formulation of ammoniacal copper. For an aqueous composition consisting essentially of copper, ammonia, and sulfate or carbonate, we define the ratio of ammonia to copper in the copper-ammonium complex as 3.5 moles ammonia per mole of copper. Therefore, a composition having 4 moles ammonia per mole of copper will have 0.5 moles of ammonia as base per mole of copper. Preferably, such compositions will also have at least 0.1 mole equivalents, preferably at least 0.2 mole equivalents, of a non-amine base per mole of copper.

Other biocidal metals can be utilized, though copper is the preferred metal. For example, nickel and zinc can also be used in wood treatment as a soluble amine complex.

In a second aspect of the invention, wood is preserved by: 1) contacting the wood with a composition comprising a base, such that an amount of the base covers a surface of the wood or is absorbed into the wood; and 2) injecting into the wood comprising the base with an aqueous solution comprising at least one copper amine complex. In one embodiment the composition comprising a base is a gas which on contact with water forms a base, for example ammonia gas. In the preferred embodiments, the composition comprising the base is an aqueous composition comprising at least one base in an amount sufficient to provide at least about 0.02, preferably 0.03 or greater, and more preferably 0.05 or greater, for example between about 0.05 and about 0.3, mole-equivalents of base per liter of aqueous solution. Preferably at least a portion of the base is not an amine. A preferred amount of base is between about 0.05 and about 0.2 mole-equivalents of base per liter of aqueous solution.

Wood comprises a variety of acids, and water within wood pores is often thought to have a pH of about 4 to about 5.5. Generally, a copper amine complex may be injected at a pH of about 7.5 to about 8. The solubility of copper MEA carbonate, for example, is steep in the range of <5 and >8 and hits a minimum at about pH 6. As the injected copper amine complexes flow through the wood, the wood continues to remove amines until the copper can no longer be kept in solution. The copper thus precipitates out, usually in a gelatinous phase, plugging the wood and not allowing further flow of preservative. In all aspects of this invention, the intent is to provide sufficient base to the injected solution to prevent gelatinous copper precipitation. The base is advantageously sufficiently strong to neutralize (and often bind with) acids in the wood, to reduce the tendency of these acids to strip amine from the copper amine complexes. Since the first injected solution of copper amines is typically the portion that faces the greatest distances of travel through wood, this first portion is the portion requiring protection. In turn, as many acids near the wood surface are already neutralized by the time half the preservative solution is added, the added base in the later-injected preservative solution has little value in terms of preventing precipitation of copper. Therefore, in each of the first and third through sixth aspects of the invention described above, it can be advantageous to inject a first portion of the aqueous solution comprising the copper amine complex and the base into the wood, and subsequently inject a second portion of an aqueous solution comprising the copper amine complex and optionally but not necessarily comprising the base into the wood. While it may be most advantageous in terms of chemical use to reduce the amount of base as the injection proceeds, the industry is strongly antagonistic to multi-step processes. Although two step injection processes are greatly disfavored, this process can be readily achieved by adding a first aliquot of material to an injection chamber, where this aliquot comprises the base and contacts a substantial portion of the wood surfaces, and then adding a second aliquot of aqueous solution comprising the soluble copper amine complex, such that the total amount of base Similarly, the second aspect of the invention can be realized in a similar manner, or by simply for example pre-wetting the wood with an alkaline solution, minutes or days before the injection process. Such variations are within the scope of the invention.

The most preferred bases for this second aspect of the invention include alkali metal carbonates, alkali metal phosphates, ammonia, alkanolamines, and the like. The operator is cautioned that if high concentrations of an alkali metal hydroxide (or high concentrations of alkali metal oxide which quickly convert to the hydroxide) are present, the hydroxide can destabilize the copper amine complex and result in copper hydroxide precipitation.

In a third aspect of the invention, wood is preserved by: 1) providing an aqueous solution comprising at least one copper amine complex and at least one base in an amount sufficient to provide at least about 0.2, preferably 0.4 or greater, and more preferably at least 1 or greater, for example between about 2 and about 4, mole-equivalents of base for each mole of copper; wherein the base is not an amine; and 2) injecting the solution comprising the copper amine complex and the base into wood. In an alternate third aspect of the invention, wood is preserved by: 1) providing an aqueous solution comprising at least one copper amine complex and at least one base in an amount sufficient to provide at least about 0.2, preferably 0.4 or greater, and more preferably at least 1 or greater, for example between about 2 and about 4, mole-equivalents of base for each mole of copper; wherein the base is not an amine present in the copper amine complex(es); and 2) injecting the solution comprising the copper amine complex and the base into wood.

This third aspect of the invention emphasizes the use of non-amine bases, thereby promoting the non-leaching and lower corrosivity aspects of compositions having strong, non-amine bases.

In a fourth aspect of the invention, wood is preserved by: providing an aqueous solution comprising at least one soluble copper amine complex and at least one base in an amount sufficient to provide at least about 0.01, preferably 0.02 or greater, and more preferably 0.03 or greater, for example between about 0.04 and about 0.3, mole-equivalents of base per liter of aqueous solution, wherein the base is not an amine; and injecting the solution comprising copper amine complex and the base into wood. A preferred amount of base is between about 0.05 and about 0.2 mole-equivalents of base per liter of aqueous solution.

This fourth aspect of the invention emphasizes the use of non-amine bases, thereby promoting the non-leaching and lower corrosivity aspects of compositions having strong, non-amine bases. Additionally, this fourth aspect of the invention acknowledges that the quantity of amine necessary to neutralize acids in the wood is only peripherally related to the concentration of copper amine complex in the solution. Such a method of specifying the amount of base is useful when, for example, the operator wishes to treat the diluent water rather than adding bases to the concentrate. The fifth and sixth aspects of the invention are similarly useful in the same context.

In a fifth aspect of the invention, wood is preserved by: providing an aqueous solution comprising at least one soluble copper amine complex and at least one base in an amount sufficient to provide at least about 0.02, preferably 0.03 or greater, and more preferably 0.05 or greater, for example between about 0.05 and about 0.3, mole-equivalents of base per liter of aqueous solution, wherein at least a portion of the base is not an amine; and injecting the solution comprising copper amine complex and the base into wood. A preferred amount of base is between about 0.05 and about 0.2 mole-equivalents of base per liter of aqueous solution.

In a sixth aspect of the invention, wood is preserved by: providing an aqueous solution comprising at least one soluble copper amine complex and at least one base in an amount sufficient to provide at least about 0.03, preferably 0.04 or greater, and more preferably 0.06 or greater, for example between about 0.05 and about 0.4, mole-equivalents of base per liter of aqueous solution; and injecting the solution comprising copper amine complex and the base into wood. A preferred amount of base is between about 0.05 and about 0.2 mole-equivalents of base per liter of aqueous solution.

Advantageously, the amount of added base provides at least about 0.05 equivalents, for example about 0.25 equivalents or greater, per equivalent of amine in the copper amine complexes in solution.

By “less-corrosion-inducing” we mean the wood preservative has a reduced tendency, compared to a similar concentration of copper obtained from the soluble copper treatments such as the amine-copper-complex treatments and alkanolamine-copper-complex treatments in use today, to corrode of metal that contacts the wood.

The most common commercial procedures for impregnating wood involve contacting the wood with the preservative under a relatively high pressure, for example, 50-200 psi (pounds per square inch) for a period of time, such as from one-half hour to twenty four hours. The process can alternately, or beneficially additionally, utilize vacuum to aid penetration of the preservative into the wood. The processing may also require relatively high temperatures in the range from about 75° C. to about 110° C.

The composition can advantageously additionally comprise chelators to prevent alkaline earth metal carbonate, e.g., calcite, precipitation. The wood preservatives are typically shipped and stored as concentrates that are at least 5 times, for example, at least about 15 times, for example about 40 times more concentrated than the wood preservative as generally applied to wood or wood products. In many formulations, there is several percent carbonate in the concentrate, which helps stabilize the copper amine complexes in the concentrate. On site, the wood preservative concentrate is diluted with water prior to treatment of the wood. Generally, a composition comprising between 0.25% and 2% by weight copper is injected into wood during the wood preservation process, so the dilution may range from 1 part concentrate to 3 parts water to 1 part concentrate to 64 parts water. Base, as the term is used with the current invention, can be added to the concentrate, to the water, or during the mixing process. We note that the preferred bases are hydroxides and carbonates. The very high carbonate concentrations in the concentrate and in the injectable product will make even fairly soft water form scale. Water used to prepare a wood preservative does not have to be hard in order to yield precipitates. In one study it has been observed that precipitates are visible within 24 hours from waters that contain only about 100 ppm hardness, which is considered fresh (soft) water.

As a result the use of alkaline earth metal hydroxides and oxides is not preferred. In view of the large excess of carbonate that typically is found, the inhibition effort beneficially focuses on the calcium and magnesium (and strontium, if present). While it may seem trivial to simply add a large excess of chelators such as EDTA to a system to chelate any potential calcium and magnesium in the waters during mixing, such an approach is not practicable unless the inhibitors are added to the water prior to mixing. The concentrate comprises a large quantity of copper, where the copper is complexed by the interactions of the copper and between 3 and 4 amine molecules, e.g., ammonia or monoethanolamine. Strong chelators provided in the concentrate will simply strip copper from the complexes during shipment and storage of the concentrate, and/or during the dilution process. The strong chelators will then be exhausted and will not have capacity to bind with the calcium, magnesium, and/or strontium in water.

Preferred precipitation inhibitors should complex selectively with calcium, magnesium, and/or strontium as compared to copper, and thus prevent the precipitation of alkaline earth carbonates (such as e.g. calcium carbonate) from aqueous solution. Applicants have found that certain phosphonate compounds, especially those having a plurality of phosphonate groups separated by two or three atoms, typically carbon, could solubilize calcium and magnesium ions in a wood preservative composition. The mechanism is most likely that the compounds complex the alkaline earth ions. Preferred compounds have a plurality of phosphonate moieties, where the phosphonate moieties are separated by two atoms in a molecule—preferably two carbons, and less preferably a carbon and a nitrogen, for example. Molecules having three atoms between phosphonate moieties are useful but are less preferred.

The most common example, and the most effective inhibitor having these properties, is hydroxyethylidene diphosphonic acid (HEDP), also called (2-Hydroxy-2-phosphono-ethyl)-phosphonic acid. One mole of HEDP, having two phosphonate moieties per molecule, can apparently complex and solubilize about 1.5 moles calcium and 2 moles of magnesium in a copper- and carbonate-containing solution that has an excess of calcium and magnesium ions. In a copper-monoethanolamine-carbonate concentrate having excess calcium (but no magnesium), a mole of HEDP was able to solubilize about 4 moles of calcium. HEDP is preferred because it is effective and it has the greatest calcium stabilizing capacity per acid group. Generally, alkali metal salts of HEDP are preferred.

Alternately, the inhibitor molecule can have a phosphonate moiety and one or more carboxylate moieties, again advantageously separated by two atoms. For example, 2-phosphonobutane-1,2, 4-tricarboxylic acid (PBTC) has a phosphonate moiety separated from a first carboxylate by a single carbon, from a second carboxylate by two carbons, and from a third carboxylate by three carbons. One mole of PBTC, having one phosphonate and three carboxylate moieties per molecule, can apparently complex and solubilize about 1.5 moles calcium and 0.6 moles of magnesium in a copper- and carbonate-containing solution that has an excess of calcium and magnesium ions. This compound is preferred because of its activity, but it contributes 50% more acid (if used in the acid form) than does HEDP, and it has less calcium and magnesium sequestering activity than does HEDP.

The remaining common sulfonate-based scale prevention compounds are not preferred. Amino-tri(methylenephosphonic) acid (ATMP), which has three phosphonates, each separated by three atoms —C—N—C—, but where the N is shared by all three phosphonate moieties. ATMP surprisingly had little beneficial effect.

A concentrate should generally contain between 0.014 moles and 0.38 mmoles of HEDP per liter to prevent precipitation of scale during preparation and use of wood preservative compositions. However, high amounts of phosphonate-based inhibitor in a concentrate are very expensive, and also contribute an excess of acid, and it is generally not needed for most dilution factors and for softer waters. A concentrate containing between 20 and 100 mmoles/L of HEDP is a preferred embodiment. Alternately, a concentrate should contain about 150 to about 300 ppm of HEDP. The inhibitor should be added as a basic compound, or at least partially neutralized, to not tie up the base in the composition.

### EXAMPLES

### Example 1

### Corrosion Test

The corrosive effect of wood preservative solutions was investigated utilizing a screening test modeled after an American Wood Preserving Association's corrosion test. The methodology involved starting with scintillation vials filled approximately half-full with the treating solutions. The treating solutions used each contained about 0.22% by weight. They were made by forming a concentrate, and then diluting the concentrate with fresh water. The concentrations of the concentrates are shown below:

| | Sample # | | | |
|---|---|---|---|---|
| | 1(comp) | 2 | 3 | 4(comp) |
| Description | Normal | “+MEA” | +Soda Ash | NaNO₂ |
| Cu, wt. % | 9 | 9 | 9 | 9 |
| MEA, wt. % | 32 | 62 | 32 | 32 |
| carbonate, wt. % as CO₂ | 6 | 6 | 6 | 6 |
| Water, wt. % | 53 | 23 | 27 | 27 |
| Sodium Carbonate, wt. % | 0 | 0 | 26 | 0 |
| Sodium Nitrite | 0 | 0 | 0 | 26 |

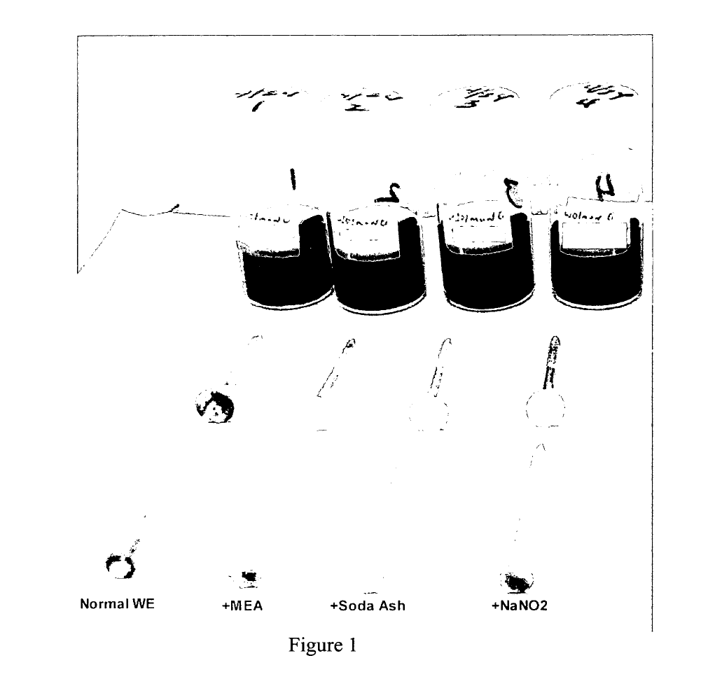

These concentrates were then diluted one part concentrate to 40 parts water to give 0.2% copper, which is approximately the strength routinely used to preserve Southern Pine. For each treating solution, two vials were utilized. A 1010 steel nail facing head down and extending about half way out of the solution was added to the first vial. The second vial contained a hot dipped galvanized steel nail and an electrogalvanized nail, both of which were placed facing head down and extending about half way out of the solution. The nails were exposed to the treating solutions for two weeks after which they were taken out of the solution, washed and quantitatively compared, where severe corrosion is a 5, modest corrosion is a 3, light corrosion is a 1, and no visible corrosion is a 0. FIG. 1 shows photographs of the dipped galvanized and electrogalvanized nails used in corrosion tests after exposure to the treating solutions. With reference to FIG. 1, it should be noted that undesirable corrosion is visible by the dark staining on the nails. The more visible staining, the more the nail was corroded. The first row of nails with the small heads are electrogalvanized nails and the second row of nails are dipped galvanized nails.

Corrosion was substantial for comparative Sample #1, averaging 4.5 out of 5 for the two nails shown. The electrogalvanized nail showed substantial corrosion, while the dipped galvanized nail showed severe corrosion. Comparative sample 1 contained about 0.2% copper, 0.7% MEA, 0.14% carbonate as CO₂, and balance water, which approximates a preservative solution that is extensively used commercially.

Corrosion was less severe for comparative sample #4, averaging 2.5 out of 5 for the two nails shown. The 0.6% sodium nitrite, an antioxidant, in the diluted treatment sample in comparative sample 4 inhibited, but did not eliminate, corrosion from both the electrogalvanized nails nor from the dipped galvanized nails.

Corrosion was light for sample 2, averaging about 1 out of 5 for the two nails shown. There was very little corrosion observed on the galvanized nails. Sample 2 differed from sample 1 in that the concentration of MEA was increased from 0.7% to about 1.4%. The slight excess of MEA therefore inhibited corrosion.

However, the results were most striking for sample 3, containing added soda ash. The corrosion was <0.5 for both the steel and for the galvanized nails shown. The 0.6% sodium carbonate in Sample 3 contained approximately the same equivalents of base as did the added 0.7% of MEA in sample 2, but the corrosion-reducing effect of the soda ash clearly exceeded that of the added MEA. In the absence of additives, a copper-MEA wood preservative solution has corrosive properties, but the addition of an alkali metal carbonate reduced or eliminated corrosion.

### Example 2

### Penetration Test

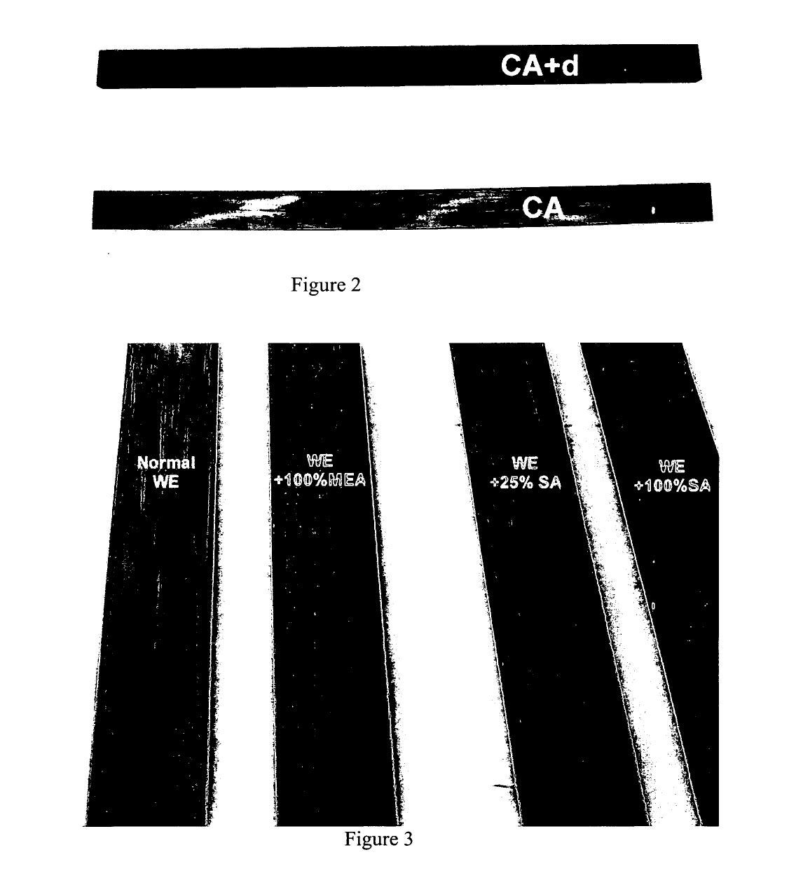

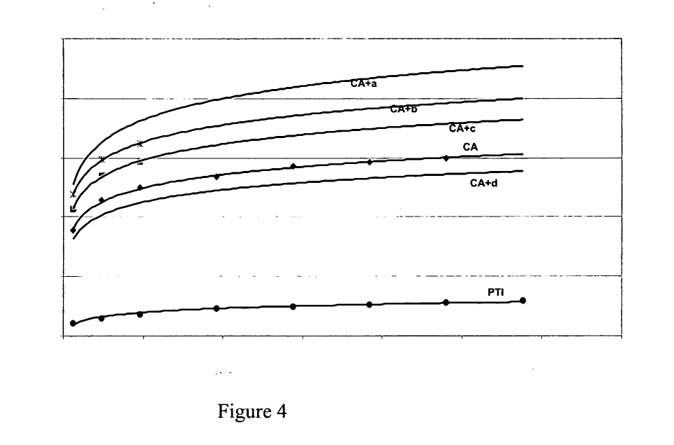

The extent to which to wood preservative penetrates the wood was investigated. Southern Pine strips were dipped into wood preservative solutions containing the following compositions: The wood planks were immersed for a predetermined time in an aqueous solution of tebuconazole (TEB) (added as an emulsion at 3% of the weight of the copper) and copper methanolamine carbonate. Comparative sample 5 contained ˜0.001% of TEB, about 0.22% copper, 0.8% MEA, 0.16% carbonate as CO₂, and balance water, which is believed to approximate the commercially available Wolman E® treatment; sample 6 contained the same components as comparative sample 5, but the MEA content was increased to 1.5%; sample 7 contained the same components as comparative sample 5, but also included ˜0.16% soda ash; and sample 8 contained the same components as comparative sample 5, but also included ˜0.6% soda ash. After a certain time, the wood strips were taken out of solution and examined. Photographs of wood strips used are shown in FIGS. 2 and 3. With reference to these Figures, lighter areas indicate copper precipitate is present, while conversely the darker the wood appears, the less preservative precipitation was observed. The presence of precipitation is indicative of poor penetration of the inhibitor. The formulation of comparative sample 5 was shown to poorly penetrate the wood when compared to the other three solutions. Both Sample 6 and sample 8 showed significant penetration and little or no evidence of precipitation. Sample 7, containing only one fourth the soda ash as sample 8, gave results which, while substantially better than those observed for comparative example 5, were demonstrably inferior to the results observed for sample 8.

### Example 3

### Leaching Tests

Leaching data from wood was measured following the AWPA Standard Method E11-97 procedure. The standard was a sample impregnated with the composition of comparative sample 5. At 0.2% additional MEA, giving 1% in the treating solution, penetration was enhanced but leaching rate of copper from the wood increased by 20% relative to the standard. At 0.7% added MEA, giving 1.5% MEA in the treating solution, penetration was greatly enhanced but the leaching rate of copper from the wood increased by 44%.

In contrast, Soda ash at 0.16% (the same number of base equivalents as the 0.2% added MEA) enhances penetration dramatically and mitigates leaching. This sample has a copper leach rate that was 9% lower than the standard.

The scope of this invention is described by the claims, and the examples and data presented are exemplary and do not limit the scope of the invention. Various aspects and features of the present invention have been explained in relation to beliefs or theories, although it will be understood that the invention is not bound to any particular belief or theory. Further, although the various aspects and features of this invention have been described with respect to preferred embodiments and specific examples, it will be understood that the invention is entitled to protection within the full scope of the issued claims.

1. A method of preserving wood comprising the steps of:
a) providing an aqueous solution comprising at least one soluble copper amine complex and at least one base in an amount sufficient to provide at least about 1 mole-equivalents of base for each mole of soluble copper amine complex; and
a) injecting the solution comprising copper amine complex and the base into wood.

2. The method of claim 1 wherein at least one amine in the copper amine complex comprises ammonia.

3. The method of claim 1 wherein at least one amine in the copper amine complex comprises ethanolamine.

4. The method of claim 1 wherein the base comprises alkali metal carbonates, alkali metal hydroxides, basic phosphate, basic pyrophosphate, basic borate, or mixtures thereof.

5. The method of claim 1 wherein the base comprises a basic salt of a C1 to C6 mono- or poly-carboxylic acid, a basic salt of a C1 to C6 mono- or poly-sulfonic acid, or combination thereof.

6. The method of claim 1 wherein the base comprises ammonia, an alkanolamine; a diamine, a polyamine; or mixtures or combinations thereof, and the base is present in an amount sufficient to provide at least about 1.5 mole-equivalents of base for each mole of soluble copper amine complex.

7. The method of claim 1 wherein the base comprises an alkali metal carbonate or an alkali metal hydroxide and at least one of ammonia, an alkanolamine; or a diamine.

8. The method of claim 1 wherein the aqueous solution comprises hydroxyethylidene diphosphonic acid or salt thereof.

9. A method of preserving wood comprising the steps of:
a) contacting the wood with a composition comprising a base, such that an amount of the base remains on or in the wood; and
a) injecting an aqueous solution comprising at least one copper amine complex into the wood comprising the base.

10. The method of claim 9 wherein the composition comprising a base is a vapor comprising ammonia gas.

11. The method of claim 9 wherein the composition comprising a base is an aqueous composition comprising at least one base in an amount sufficient to provide at least about 0.02 mole-equivalents of base per liter of aqueous composition.

12. The method of claim 9 wherein at least one amine in the copper amine complex comprises ammonia.

13. The method of claim 9 wherein at least one amine in the copper amine complex comprises ethanolamine.

14. The method of claim 11 wherein the base comprises alkali metal carbonates, alkali metal hydroxides, basic phosphate, basic pyrophosphate, basic borate, or mixtures thereof.

15. The method of claim 9 wherein the composition comprising a base is an aqueous composition comprising at least one base in an amount sufficient to provide at least about 0.05 mole-equivalents of base per liter of aqueous composition, and wherein the base comprises ammonia, an alkanolamine; a diamine, a polyamine; or mixtures or combinations thereof.

16. The method of claim 9 wherein the aqueous solution comprises hydroxyethylidene diphosphonic acid or salt thereof.

17. A method of preserving wood comprising the steps of:
a) providing an aqueous solution comprising at least one copper amine complex and at least one base in an amount sufficient to provide at least about 0.2 mole-equivalents of base for each mole of copper; wherein the base is not an amine; and
a) injecting the solution comprising the copper amine complex and the base into wood.

18. The method of claim 17 wherein at least one amine in the copper amine complex comprises ammonia.

19. The method of claim 17 wherein at least one amine in the copper amine complex comprises ethanolamine.

20. The method of claim 17 wherein the base comprises alkali metal carbonates, alkali metal hydroxides, basic phosphate, basic pyrophosphate, basic borate, or mixtures thereof.

21. The method of claim 17 wherein the base comprises a basic salt of a C1 to C6 mono- or poly-carboxylic acid, a basic salt of a C1 to C6 mono- or poly-sulfonic acid, or combination thereof, and wherein the base is in an amount sufficient to provide at least about 0.4 mole-equivalents of base for each mole of copper.

22. The method of claim 17 wherein the aqueous solution comprises hydroxyethylidene diphosphonic acid or salt thereof.

23. A method of preserving wood comprising the steps of:
a) providing an aqueous solution comprising at least one soluble copper amine complex and at least one base in an amount sufficient to provide at least about 0.01 mole-equivalents of base per liter of aqueous solution, wherein the base is not an amine; and
b) injecting the solution comprising copper amine complex and the base into wood.

24. The method of claim 23 wherein the amount of base is between about 0.05 and about 0.2 mole-equivalents of base per liter of aqueous solution.

25. The method of claim 23 wherein at least one amine in the copper amine complex comprises ammonia.

26. The method of claim 23 wherein at least one amine in the copper amine complex comprises ethanolamine.

27. The method of claim 23 wherein the base comprises alkali metal carbonates, alkali metal hydroxides, basic phosphate, basic pyrophosphate, basic borate, or mixtures thereof.

28. The method of claim 24 wherein the base comprises a basic salt of a C1 to C6 mono- or poly-carboxylic acid, a basic salt of a C1 to C6 mono- or poly-sulfonic acid, or combination thereof.

29. The method of claim 23 wherein the aqueous solution comprises hydroxyethylidene diphosphonic acid or salt thereof.

30. A method of preserving wood comprising the steps of:
a) providing an aqueous solution comprising at least one soluble copper amine complex and at least one base in an amount sufficient to provide at least about 0.03 mole-equivalents of base per liter of aqueous solution, wherein at least a portion of the base is not an amine; and
b) injecting the solution comprising copper amine complex and the base into wood.

31. The method of claim 30 wherein the amount of base is between about 0.05 and about 0.3 mole-equivalents of base per liter of aqueous solution.

32. The method of claim 30 wherein at least one amine in the copper amine complex comprises ammonia.

33. The method of claim 30 wherein at least one amine in the copper amine complex comprises ethanolamine.

34. The method of claim 30 wherein the base comprises alkali metal carbonates, alkali metal hydroxides, basic phosphate, basic pyrophosphate, basic borate, or mixtures thereof.

35. The method of claim 31 wherein the base comprises a basic salt of a C1 to C6 mono- or poly-carboxylic acid, a basic salt of a C1 to C6 mono- or poly-sulfonic acid, or combination thereof.

36. The method of claim 34 wherein the base comprises ammonia, an alkanolamine; a diamine, a polyamine; or mixtures or combinations thereof.

37. The method of claim 30 wherein the base comprises an alkali metal carbonate or an alkali metal hydroxide and at least one of ammonia, an alkanolamine; or a diamine.

38. The method of claim 30 wherein the aqueous solution comprises hydroxyethylidene diphosphonic acid or salt thereof.

39. A method of preserving wood comprising the steps of:
a) providing an aqueous solution comprising at least one soluble copper amine complex and at least one base in an amount sufficient to provide at least about 0.05 mole-equivalents of base per liter of aqueous solution; and
b) injecting the solution comprising copper amine complex and the base into wood.

40. The method of claim 39 wherein at least one amine in the copper amine complex comprises ammonia.

41. The method of claim 39 wherein at least one amine in the copper amine complex comprises ethanolamine.

42. The method of claim 39 wherein the base comprises alkali metal carbonates, alkali metal hydroxides, basic phosphate, basic pyrophosphate, basic borate, or mixtures thereof.

43. The method of claim 39 wherein the base comprises a basic salt of a C1 to C6 mono- or poly-carboxylic acid, a basic salt of a C1 to C6 mono- or poly-sulfonic acid, or combination thereof.

44. The method of claim 39 wherein the base comprises ammonia, an alkanolamine; a diamine, a polyamine; or mixtures or combinations thereof, and wherein the base is present in an amount to provide greater than 0.7 mole equivalents of base per liter of aqueous solution.

45. The method of claim 39 wherein the base comprises alkali metal carbonates or alkali metal hydroxides and at least one of ammonia, an alkanolamine; or a diamine.
